(19) United States
(12) Patent Application Publication
(10) Pub. No.: US 2008/0116075 A1
(43) Pub. Date: May 22, 2008

(54) Method of Assessing the Risk of Whiskers Appearing on the Surface of a Metallic Deposit

(76) Inventors: David Mention, Lyon (FR); Stephane Menard, Lyon (FR)

Correspondence Address: CLARK & BRODY, 1090 VERMONT AVENUE, NW, SUITE 250, WASHINGTON, DC, 20005, US

(21) Appl. No.: 11/578,123

(22) PCT Filed: Apr. 14, 2005
(86) PCT No.: PCT/FR05/00901

§ 371 Date: Aug. 24, 2007

(30) Foreign Application Priority Data
Apr. 15, 2004 (FR) 0403937

(51) Int. Cl. C25D 5/00; G01F 1/64; B32B 3/10

(52) U.S. Cl. 205/81; 205/791.5; 428/131

(57) ABSTRACT

The invention relates to a method of assessing the risk of whiskers appearing on the surface of a metallic deposit, a pure metal deposit or an alloy deposit on a substrate, using a measurement of the electrochemical impedance of the metallic deposit.

This present invention concerns the technical area of metallic deposits onto electrical or electronic components, with a view to allowing their assembly by soldering, in complex assemblies such as printed circuit boards, or indeed with a view to providing protection against corrosion of the substrate to which the deposit is applied.

In the aforementioned area, one is familiar with the application of deposits by electro-deposition of tin-lead alloys on the pins of electronic components that are capable of being mounted later on integrated circuit cards.

Such tin-lead alloys are used to create electronic components that have an optimal guarantee of solderability and reliability. However, since lead is a heavy metal which is harmful to the environment and human health, there is now a search for new deposits of pure metal or of metal alloys without lead, that are capable of taking the place of the tin-lead alloys used up to the present. Thus, it has been proposed that deposits of pure tin should be employed, for example.

However, such deposits have the major disadvantage of being favourable to the spontaneous development of crystalline growths, in form of filaments or flowers commonly known in the electronics industry as “whiskers”.

These metallic growths, which can appear on the surface of the connecting pins of electronic components, are then capable of causing short circuits and therefore general failure of the system that includes these connecting pins.

The risks associated with the appearance of whiskers on the connecting pins of electrical components are described, for example, in a TEXAS INSTRUMENTS document published in February 2003, and entitled “Whisker Assessment of Tin-Plated Logic Component Leads” by Douglas W. Romm, Donald C. Abbott, Stu Grenney, and Muhammad Khan. The risks associated with the appearance of whiskers on electronic components are also described in the context of a publication of the CALCE Consortium (Computer Aided Life Cycle Engineering, Electronic Products and Systems Center) associated with the University of Maryland, entitled “Position paper on risks to high-reliability electronics and associated hardware from pure tin coatings”, Tin Whisker Alert, and its appendices, published on 25 Jul. 2002.

The above-mentioned publications clearly highlighted the significant risks associated with the appearance of whiskers on deposits of pure tin, applied in particular to the connecting pins of electronic components.

However, given the ecological impact of using lead in the electronics industry in particular, and therefore the need to eliminate this use, it is vital to be able to develop new techniques based on pure metals or metal alloys capable of substituting for the deposition of alloys of tin and lead used at present, while still providing full guarantees, in particular concerning an absence of the risk of developing whiskers.

In addition, it should be noted that there is currently no consensus concerning the conditions that can favour the appearance of whiskers on metallic deposits.

Thus, there is an urgent need for a method which assessment, in a reliable manner, of the risk of whiskers appearing on a metallic deposit, obtained by deposition or any other process. In this regard, it should be noted that the risks of whiskers appearing are not limited to deposits of tin, and can also appear on deposits of silver, cadmium or indeed of zinc.

In order to attain this objective of predicting the appearance of whiskers, the invention proposes a process for assessing the risk of whiskers appearing at the surface of a deposit of a metal or of a metallic alloy on a substrate, where this process uses measurement of the electrochemical impedance of the deposit in order to assess this risk.

In fact, the inventors had the merit of demonstrating that the value of the electrochemical impedance of a metallic deposit is related to the propensity of this deposit to develop whiskers.

In a manner that is familiar to the professional engineer, determination of the electrochemical impedance of a product or of a deposit is effected by applying a sinusoidal potential difference of variable frequency, firstly, to a dipole that includes a working electrode, in other words the deposit to be tested, and secondly to a counter-electrode, both of which are immersed in a conducting solution, and by measuring the resulting current in this system in order to deduce its impedance.

The methods for measuring the electrochemical impedance of a system are entirely familiar to the professional engineer, and therefore need no further explanation here. If any additional information is required, reference can be made to the information in U.S. Pat. No. 6,161,969, describing a method for measuring electrochemical impedance, applied for determining the fatigue of a sample to be tested.

Reference can also be made to the following publications:
A. J. Bard & L R Faulkner, “Electrochemical Methods: Fundamentals and Applications”, Wiley, New York, 1987;
A. C. Fischer, “Electrode Dynamics”, Oxford University Press, Oxford, 1996;
P. H. Reiger, “Electrochemistry”, Prentice-Hall International, Englewood Cliffs, 1995;
Southampton Electrochemistry Group, “Instrumental Methods in Electrochemistry”, Ellis-Horwood, Chichester, 1985.

According to the invention, it is possible to effect the measurement of electrochemical impedance of a metallic deposit in one or more ranges of drive frequency or, indeed, at one single value of drive frequency.

According to the invention, measurement of electrochemical impedance in order to determine the risk of whiskers appearing can be effected in different ways.

According to a preferred but non-limiting characteristic of the invention, the process of determining the risk of whiskers appearing includes at least one stage for measuring the electrochemical impedance of the deposit to be tested or evaluated, and a second stage for comparing the value obtained during the measurement stage with a reference value.

The reference value used can also be obtained in different ways. It can, for example but non necessarily, be obtained from a mean value of the electrochemical impedance measured on different samples of one or more types of deposit known for their absence of risk of developing whiskers, or indeed known for their high risk of developing whiskers.

On much the same lines, the reference value can be the value of the electrochemical impedance measured on the deposit to be tested after the latter has been subjected to an annihilation or neutralisation process, meaning an oven treatment in a dry atmosphere at a temperature not less than 150° C. for at least one hour. Such a thermal treatment is in fact known to eliminate all risk of whiskers appearing. In the context of using as a reference the value of the electrochemical impedance of the deposit to be tested after neutralisation or annihilation of the latter, it will then be considered that the more the value of the electrochemical impedance of the deposit to be tested before any thermal treatment approaches the value of the electrochemical impedance of the same deposit to be tested after annihilation, the lower the risk of whiskers appearing on this deposit.

The reference value used in the context of the process of the invention can also correspond to another measurement of the electrochemical impedance of the deposit to be tested without the latter necessarily having been annihilated or undergone any thermal treatment.

Thus according to another characteristic of the invention, the process for assessing the risk of whiskers appearing includes at least:
a first stage for measuring the electrochemical impedance of the deposit,
a second stage for measuring the electrochemical impedance of the deposit, which occurs after a given time interval, known as the test interval,
and during the comparison stage, the reference value is taken as the value obtained during the second measurement stage, so as to determine the evolution of the electrochemical impedance of the deposit during the test interval.

According to the invention, determination of the evolution of the electrochemical impedance of the deposit can be conducted using the value of the electrochemical impedance of the deposit as measured, or indeed using the inverse value of this impedance.

Likewise, according to the invention, determination of the evolution of the electrochemical impedance of the deposit can be effected by comparison of a first measurement effected at the beginning of the test interval and a last measurement effected at the end of the test interval, or indeed by comparing a series of measurements effected during the test interval.

According to one characteristic of the invention, the assessment process includes the attribution of a high risk index of whiskers appearing to a deposit for which the inverse of the electrochemical impedance, measured at least at the beginning and end of the test interval, reduces by a value that is greater in absolute terms than 10⁻⁵, while a deposit for which the value of the inverse of the impedance varies in absolute value by a value that is greater than 2.10⁻⁵ will be given a very high risk index, and while a deposit for which the inverse of the electrochemical impedance varies in absolute value by a value that is greater than 5.10⁻⁵ will be given a particularly high risk index of whiskers appearing.

It should be noted however that such values are characteristic of a substrate that includes at least one thickness of copper, to which the deposit to be tested is applied. Now the values of the electrochemical impedance are associated with the nature of the substrate, so that the values measured for another type of substrate can correspond to a particularly high risk index for a copper substrate, while, for this other substrate, the risk of whiskers appearing will be lower. Other parameters capable of influencing the values of electrochemical impedance are the thickness of the deposit and the measurement conditions, such as the nature of the electrolyte employed, and the measurement temperature.

Thus, in an implementation variant of the invention, the process of determining the risk of whiskers appearing will include a comparison of the variation of the electrochemical impedance or of its inverse, over a test interval, on a deposit to be tested on a given substrate, with the variation of the electrochemical impedance or of its inverse measured in the same conditions, over an identical test interval, on a reference deposit, conducted on the same substrate. The reference metallic deposit can, for example, be a metallic deposit that is known for its low risk of whiskers appearing.

According to another characteristic of the invention, the process for assessing the risk of whiskers appearing includes the application of a thermal treatment to the deposit to be tested during the test interval. One can thus envisage oven-processing of the deposit to be tested and its substrate in a dry atmosphere or indeed in a humid atmosphere. In a preferred but non-exclusive manner, the deposit to be tested and its substrate will be oven-treated at a temperature of not less than 45° C., preferably in a dry atmosphere. According to another characteristic of the invention, the deposit and its substrate will be placed in an oven at a temperature of preferably between 50° C. and 150° C.

According to yet another characteristic of the invention, the process for assessing the risk of whiskers appearing includes the following stages:
choice of a test interval lasting between 20 minutes and 120 minutes,
performing a first measurement, before thermal treatment, of the electrochemical impedance of the deposit tested,
oven-treating the deposit tested during the test interval,
performing a second measurement, after thermal treatment, of the electrochemical impedance of the deposit tested,
comparing the two measurements by calculating the relative variation of the electrochemical impedance or the inverse of the impedance of the deposit tested, between the measurement effected before thermal treatment and the measurement taken after thermal treatment.

The process of the invention can be employed in order to assess metallic deposits applied to conducting substrates using different methods, such as by electro-deposition or indeed by immersion in a bath of molten metal for example. In the case of deposition by immersion, a non-conducting or insulating substrate can be used.

In a preferred but not strictly necessary application, the process for assessing the risk of whiskers appearing according to the invention will be used to effect the assessment of an electrolytic bath and of an associated electro-deposition method, for the application of a metallic deposit to a conducting substrate.

This method of assessment will then preferably include the following stages:
application of a deposit of metal or metal alloy onto a conducting substrate by electro-deposition, with organisation of the bath and the method to be assessed,
and assessment of the risk of whiskers appearing at the surface of the deposit, effected by means of the assessment process according to one of the variants described above.

In a preferred form of implementation of the assessment method, the assessment of the metallic deposit obtained by use of the electrolytic bath and of the associated electro-deposition method will be started less than 120 minutes after application of the metallic deposit.

Such a method for the assessment of a bath can then involve an intrinsic measurement of the variation of the electrochemical impedance, or involve a comparison between, firstly, the value of this variation measured for a metallic deposit effected at the start-up of the bath, which will then be the reference deposition and, secondly, the value of this variation for deposits effected during the use of the bath, at regular intervals for example.

Such a comparison can then be used to note any changes that might result in an increased risk of whiskers appearing.

Likewise, according to the invention, the method for assessing a bath can involve a comparison of the values of the electrochemical impedance of deposits during the use of the bath, with a value of the electrochemical impedance measured on one or more deposits applied when this same bath was new or with a reference bath of the same composition and new. Naturally the method of electro-deposition or of immersion employed will then be the same for all the deposits involved in the comparison.

The assessment method, according to the invention, of the risk of whiskers appearing on a metallic deposit using at least one measurement of the electrochemical impedance of the deposit, also necessitated, for its validation, the development of an assessment method by optical inspection, so as to allow an irrefutable demonstration of the validity of the method by measurement of the electrochemical impedance.

To this end, the inventors have proposed to apply the metallic deposit to a substrate, conducting or not, that includes, firstly, an electrochemical assessment zone with a surface that is capable of allowing application of the opening of a cell that includes a bath and electrodes intended to allow a measurement of electrochemical impedance, and secondly an optical inspection zone that includes at least one through hole, and preferably a series of the latter.

In fact, the inventors had the merit of pointing out that small-diameter holes, of between 0.3 mm and 1.2 mm for example, receiving a metallic deposit, provided zones that were particularly favourable to the development of whiskers within a reasonable period. Such an optical assessment method could also be considered to be a method of accelerating the development of whiskers.

Thus, to the extent that a certain number of holes are created, preferably more than 50, and between 70 and 150 for example, it becomes possible, when the deposit presents a high risk of whiskers appearing, to observe such whiskers in at least one of the holes, after a certain waiting time, by means of a binocular magnifier. The shortest time observed in the context of the tests for the appearance of whiskers, for deposits with a high risk of whiskers appearing, will be of the order of 14 hours for high-risk deposits, though this value should not be considered to exclude shorter or longer appearance times. It should be noted that such values have been observed for a substrate in which the layer to which the metallic deposit to be assessed is applied, is made of copper. Thus, other values can be observed for other types of substrate.

It has therefore been possible to effect a correlation between the results obtained by determining the evolution of the electrochemical impedance of the deposit on the test substrate and the observation of whiskers in the holes on this same test substrate.

A combination of these two assessment techniques has also been envisaged, in the context for example of measurements effected in the short term over a test interval of less than one month and, preferably, less than one week, by effecting an electrochemical assessment of the appearance of whiskers and continuing this assessment on the basis of the same samples, in the context of ageing, accelerated or not, by regular observation of the visual inspection holes for any whiskers that may appear over a longer period.

According to the invention, the test substrate liable to be used for assessment by the measurement of impedance associated with assessment by optical observation, or for assessment by optical measurement only, can be created in different ways.

Thus, preferably but not exclusively, the test substrate can consist of a plate of pure metal, such as a copper plate or a plate in a metal alloy such as brass or bronze for example, covered or not with an intermediate metallic deposit applied before the deposit to be assessed. One can also consider the use of a substrate containing no copper, such as steel or soft iron for example.

In the case of assessing a metallic deposit applied by electro-deposition, the plate of the test substrate will have a conducting surface and, as indicated above, will preferably be made of metal or a metal alloy, but can also consist of a plate of insulating material covered with an intermediate conducting layer. In the latter case, the substrate can, for example, consist of a laminated plate of epoxy resin, reinforced with glass fibre, to the surfaces of which has firstly been applied a chemical deposit of copper, and then also an electrochemical deposit of copper, with the deposit to be tested being applied afterwards of course.

On the other hand, in the case of assessing a metallic deposit applied by another means, such as by immersion for example, an insulating plate can be used.

Diverse other characteristics of the invention will emerge from the description provided below, with reference to the appended drawings which illustrate different devices or substrates capable of being used for implementation of the assessment process according to the invention.

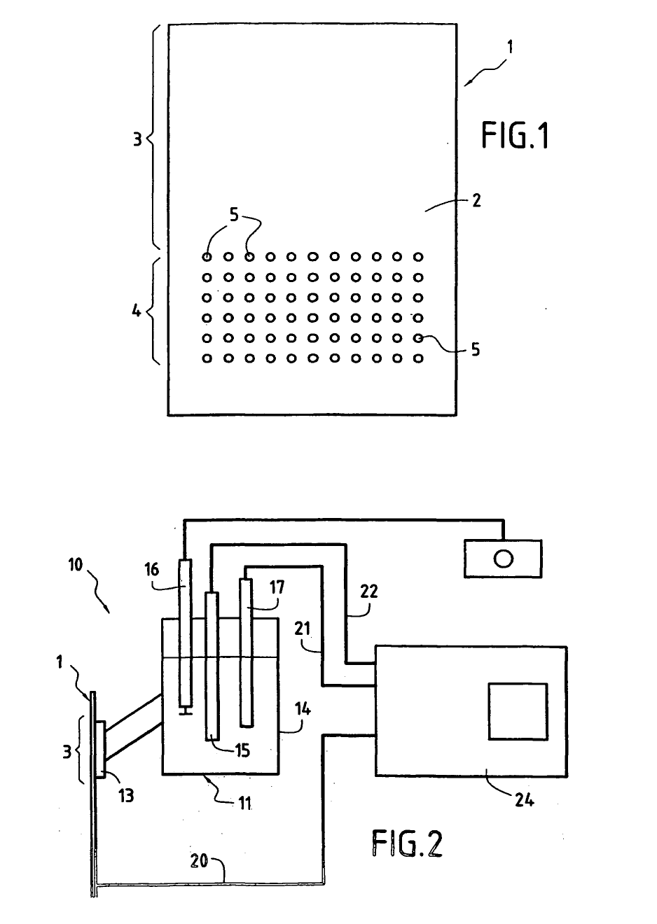

FIG. 1 is an elevation of a substrate that is suitable for use for the implementation of one or other of the methods according to the invention for assessing the risk of the appearance of whiskers.

FIG. 2 is a schematic view of an arrangement for measuring the electrochemical impedance of a metallic deposit according to the invention.

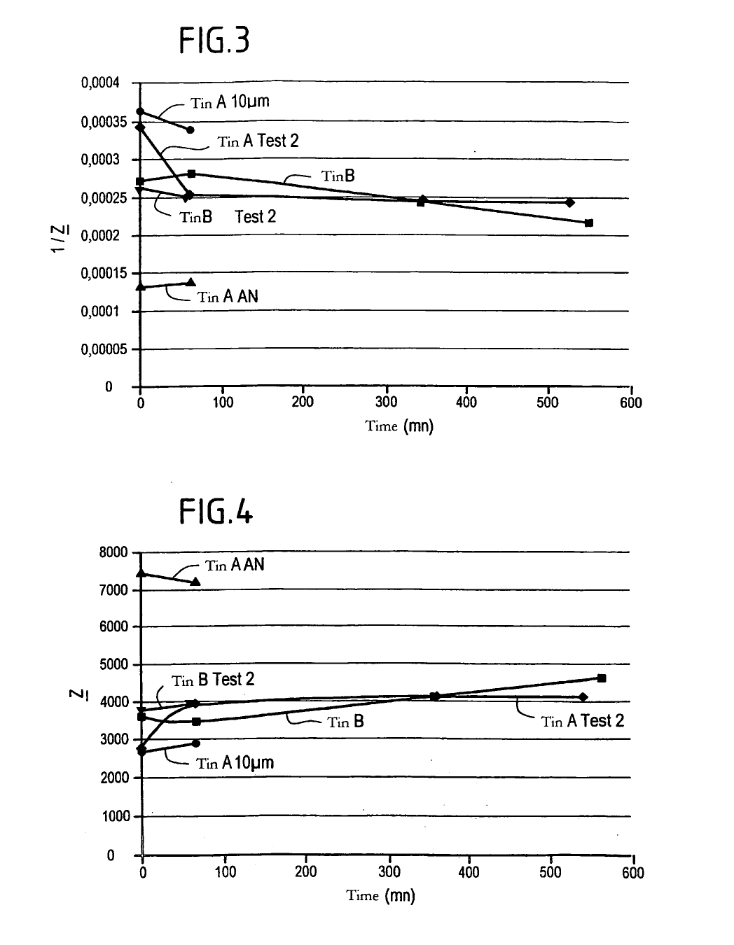

FIGS. 3 to 6 are graphs summarising the evolution over time of the values of electrochemical impedances measured for metallic deposits applied to different test substrates according to FIG. 1.

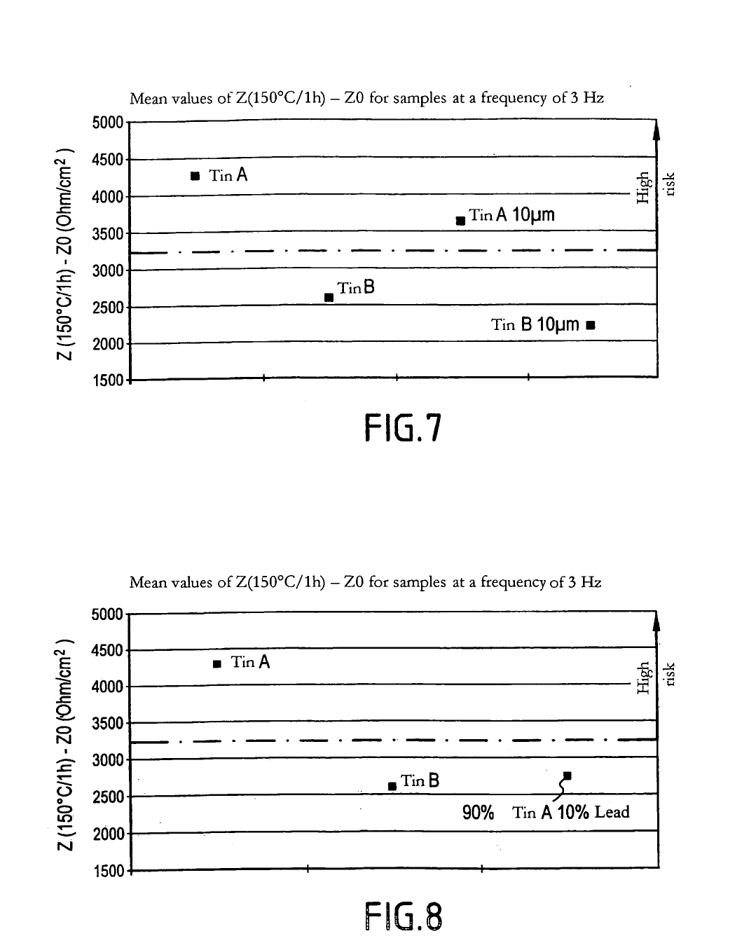

FIG. 7 to 9 are graphs summarising the comparison, by subtraction, for different metallic deposits, of the value of the electrochemical impedance measured for each deposit before any thermal treatment, with the value, known as the reference value, of the electrochemical impedance of the same deposit measured after annihilation or neutralisation of the latter.

FIG. 10 is a summary graph, for different metallic deposits, of the comparison, by subtraction, of the value of the electrochemical impedance measured for each deposit after an oven treatment of three hours at 50° C., with the value, known as the reference value, of the electrochemical impedance of the same deposit measured after annihilation or neutralisation of the latter.

A test substrate according to the invention, as illustrated in FIG. 1 and designated as a whole by the reference 1, includes a flat plate 2 of more or less rectangular shape. According to the example illustrated, the plate 2 can include a reinforcing metal sheet, sandwiched between two sheets of epoxy resin reinforced with glass fibre, in which the plate 2 has, on its two large faces, a deposit of copper applied by chemical means and covered with a finishing layer of copper applied by electro-deposition. In a preferred but not exclusive manner, the plate 2 is chosen to have a thickness of between 1.5 mm and 3 mm.

In order to allow the implementation of a method for assessing the risk of whiskers appearing by measuring the electrochemical impedance, the plate 2 includes a solid zone 3 capable of allowing the application of an electrochemical measuring cell, as will be explained below.

In addition, in order to allow the implementation of a method for assessing the risk of whiskers appearing by optical observation, the plate 2 also includes a perforated zone 4 having a series of through holes 5. According to the example illustrated, the holes 5 have a circular shape with a diameter of between 0.3 mm and 1.2 mm, and are laid out in a grid pattern. Naturally other hole shapes, arranged in a different pattern, can equally well be adopted. It should be considered that, according to the example illustrated, the perforated zone 4 has twelve holes with a diameter of 0.3 mm, twenty four holes with a diameter of 0.8 mm, thirty holes with a diameter of 1 mm, and twenty four holes with a diameter of 1.2 mm, making a total of ninety holes 5.

The test substrate thus created can then be subjected to the deposition of a metal or a metallic alloy to be assessed, over all of its surface, namely not only its two large faces, but also a part at least of the internal surface of the holes 5. The deposition can be performed in any appropriate manner.

In the context of the tests, with a view to validation of the methods of the invention for assessing the risk of whiskers appearing, five types of pure tin deposits were applied by electrochemical means using baths with diverse formulations, on substrates 1 as described above.

In general, each deposition of tin was applied in a 2-litre rectangular electrolytic tank filled with 1.75 litres of bath material, with two rectangular tin anodes being placed facing and parallel to each other in the tank, while a cathode, formed by the substrate 1 to be covered, is placed between the two anodes and equidistant from the latter. A cathodic current is then applied at a density selected to obtain a tin thickness of 1.5±0.5 gm on the test substrate 1. When the deposit has been laid, the covered substrate is dried with hot air at a temperature of less than 30° C.

In the context of the validation tests, two types of pure shiny tin were applied from electrolyte bath formulations that includes 10 g/l of tin metal introduced in the form of tin methanesulfonate at 200 g/l, 150 ml/l of methane sulfonic acid at 70%, and additives to obtain a shiny tin deposit. The additives include one or more surfactants, such as alkylene or polyalkylene oxide compounds for example, as well as one or more organic shining products like aldehydes or cetones for example.

For the tests, seven metallic deposits were applied for testing, referenced in the following way with reference to FIGS. 3 to 6.

TIN A,

TIN A test 2,

TIN A 10 μm, namely a deposit with a thickness of 10 μm instead of 1.5 μm,

TIN A AN, corresponding to a deposit of the TIN A annealed type, meaning annihilated or neutralised,

TIN B,

ETA1N B test 2.

Measurement of the electrochemical impedance of each substrate thus covered with a metallic deposit, and requiring to be assessed, are effected by means of an arrangement such as that particularly illustrated in FIG. 2. Such an arrangement for measuring electrochemical impedance, designated as a whole by the reference 10, includes a measurement cell 11 which is composed of a receptacle 12 having an opening 13 intended to be applied against zone 3 of the substrate 1. The opening 13 of the receptacle 12 then has the advantage of defining, in a repeatable manner, the deposition area to be tested, and whose electrochemical impedance will be measured. According to the example illustrated, the opening 13 is placed laterally, and oriented vertically. However, according to the invention, it is also possible to use a measurement cell whose opening is located at the bottom of the receptacle with a horizontal orientation.

After positioning the substrate 1 at the opening 13, the receptacle 12 is filled with an electrolytic solution chosen for its absence of chemical reaction in relation to the metallic deposit to be tested.

In the context of the tests performed, for validation of the proposed methods, a basic buffer solution was used as an electrolyte, with the following formulation:
tetraboric acid made by Chimie Plus, H₃BO₃, at a concentration of 6.18 g/l,
sodium borate, decahydrate, made by Chimie Plus, Na₂B₄O₇_{, 10}H₂0 at a concentration of 9.55 g/l,
and the solvent used is deionised water.

Naturally, here this is a non-exclusive example of electrolyte, and other formulations of electrolyte can be used equally well, preferably of the buffer type.

A volume of electrolyte 14 of 75 ml±5 ml is poured into the receptacle 12 at ambient temperature.

Then introduced into the electrolyte 14 is an Ag/AgCI electrode 15 in a solution of 3M potassium chloride saturated in Ag, such as that marketed by Radiometer Analytical for example, under the reference XR300.

Also placed in the electrolyte 14 will be a rotating disk electrode 16, such that marketed by Radiometer Analytical for example, under the reference EDI 101, with the rotating disk electrode 16 then being arranged to effect continuous stirring during the measurements. Naturally, any other stirring method could be used, as long as it does not affect the quality of the measurements.

Finally placed in the receptacle 12 and the electrolyte 14, is an auxiliary platinum electrode 17, such as that marketed under the reference XM 110 by Radiometer Analytical for example.

Naturally, other types of electrochemical measurement equipment can be used equally well.

The working electrode, composed of the surface of the substrate 1 covered with the metallic deposit, closing off the opening 13, as well as the auxiliary electrode 17 and the reference electrode 15, are connected by lines 20, 21, 22 to an impedance measuring device, such as a Voltalab PST050 potentiostat marketed by Radiometer Analytical for example.

Measurements on the TIN A, TIN B, TIN B test 2 and TIN A 10 micrometre samples were performed in the following manner.

After application of the metallic deposit and drying, the electrochemical impedance of each metallic deposit was measured, preferably but not exclusively within a period of 120 minutes from the end of the electro-deposition process. According to the example illustrated, it was chosen to measure this electronic impedance for a given frequency, between 1 Hz and 10 Hz, or whose decimal log is between 0.25 and 0.75 and, preferably 0.5. However, a different value of frequency can be considered or indeed it can be decided to use the mean value of the electrochemical impedance over a given range of frequencies, such as between 10 mHz and 100 kHz.

After this first measurement has been taken, the samples are placed in an oven for a period of 60 minutes at a temperature of 50° C.±0.5 in a dry atmosphere. At the end of these 60 minutes, the electrochemical impedance of the samples is measured again using a method that is strictly identical to that adopted for the first measurement.

The graph in FIG. 3 illustrates the values thus measured for samples TIN A, TIN B, TIN A AN, TIN B test 2 and TIN A 10 μm, which are represented using the inverse of the electrochemical impedance measured. For samples TIN A and TIN B, an inverse evolution of the electrochemical impedance over time beyond 60 minutes is also shown.

FIG. 4 illustrates the evolution over time of the electrochemical impedance for the same samples as those of FIG. 3.

In fact, within the meaning of the invention, the electrochemical impedance and the inverse of the electrochemical impedance can be used without distinction in order to assess the risk of whiskers appearing.

Concerning the TIN A annealed sample, it should be mentioned that to begin with, after application of the metallic deposit, the latter is subjected to a thermal neutralisation or annealing process, also known as annihilation, in an oven in a dry atmosphere for a period of 1 hour at a temperature of 150° C.±0.5° C. In fact, it is currently accepted that such a metallic deposit of pure tin which has undergone this thermal treatment has a very low risk of developing whiskers. Once the thermal annihilation treatment has been completed, the sample is returned to ambient temperature in order to be subjected to the first measurement, as described previously. The sample is then place in an oven at 50° C.±0.5° C. in a dry atmosphere for a period of 60 minutes and is then subjected to a second measurement, also as described previously. The results of these two measurements are shown in the graphs of FIGS. 3 and 4.

The inventors then had the merit of pointing out that a very high variation of the electrochemical impedance between the first and the second measurement corresponded to a high risk index of whiskers appearing. Thus the TIN A sample was assigned an index of very high risk or particularly high risk of whiskers appearing, and the optical test as performed in zone 4 of the sample by means of the series of holes to which the metallic deposit was also applied revealed the appearance of whiskers in at least one of these holes within a period of 14 hours. It should be noted that in the absence of thermal treatment, and when maintained at ambient temperature, whiskers appeared within a period of fifteen days.

On the other hand, given the small slope of the graph representing the inverse of the electrochemical impedance between the start and the end of the test interval, the sample, TIN B test 2, was assigned an index of low risk of whiskers appearing, as well as the TIN A AN or TIN A annihilated sample, which were also assigned an index of low risk of whiskers appearing. This assessment was also confirmed in the context of the optical assessment, to the extent that no whisker appeared in any of the holes of zone 4 of each sample and after a period of maintenance at 50° C.±0.5° C. of more than 1600 hours.

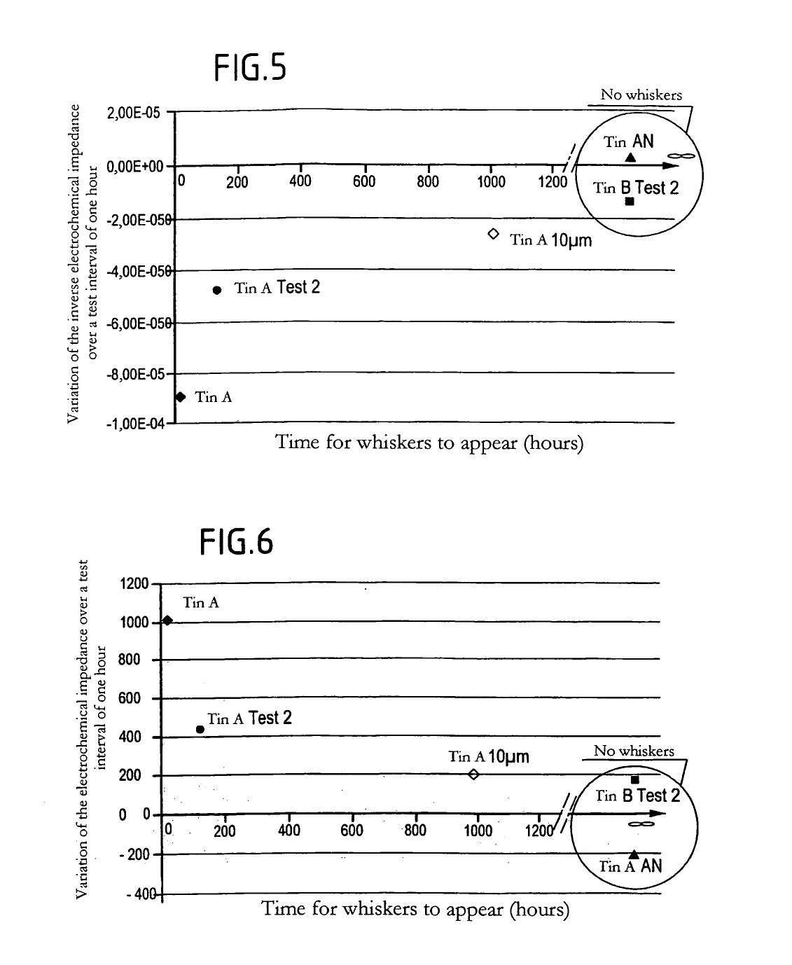

The process for assessing the risk of whiskers appearing, using the determination, over a given time interval of possibly variable length, of the evolution of the electrochemical impedance of the deposit to be assessed, can be used alone or in combination with the method for assessing the risk of appearance of whiskers by optical observation. Thus FIGS. 5 and 6 represent on a graph, firstly, the variation, over a test interval of 60 minutes, of the inverse of the electrochemical impedance of FIG. 5 or of the electrochemical impedance of FIG. 6, and secondly the time for the appearance of the whiskers in at least one hole 5 in the substrates, for samples TIN A, TIN A Test 2, TIN A 10 μm, TIN B test 2 and TIN A AN.

In the context of their demonstration of the correlation between the value of the electrochemical impedance of a deposit and the risk of whiskers appearing, the inventors developed another way to use the measurement of the electrochemical impedance of the invention in order to assess the risk of whiskers appearing. According to this other method of implementation, to begin with, a first measurement is taken of the electrochemical impedance Z₀ of a deposit to be tested using the procedure described previously. This first measurement Z₀ is effected at ambient temperature and at a frequency of 3 Hz, while the deposit to be tested is effected having undergone no thermal treatment. Next, the deposit to be tested is subjected to a process of neutralisation or annihilation as described previously, being annealed in a dry atmosphere at a temperature of 150° C. for a period of one hour. After cooling, a second measurement is taken of the electrochemical impedance Z_{(1h00,150°C.)} of the deposit to be tested. This second measurement of Z_{(1h00,150°C.)} is effected in the same conditions as the first measurement. The value of the first measurement is then compared with the value of the second measurement, corresponding to the reference value. Here, this comparison is effected by subtraction, and the mean of the values Z_{(1h00,150°C.)}-Z₀ is transferred to in FIG. 7, which shows a graph of these comparisons for samples TIN A, TIN A 10 μm, TIN B and TIN B 10 μm. It emerges that the samples for which the difference is greatest are those which have the highest risk of whiskers appearing. Thus a high risk index of whiskers appearing is attributed to the samples whose difference is greater than 3250 ohm/cm².

FIG. 8 shows a graph in which the mean values of the difference Z_{(1h00,150°C.)}-Z₀ for samples TIN A and TIN B, and of the samples of a deposit of a tin lead alloy composes of 90% of TIN A and 10% of Lead by weight. It should be noted that The mean value of the difference Z_{(1h00,150°C.)}-Z₀ is less than 3250 ohm/cm², so that, according to the invention, this alloy is considered as having a low risk of whiskers appearing, which actually corresponds to what is known, to the extent that it is commonly accepted that the presence of lead reduced or even eliminates the risk of whiskers appearing.

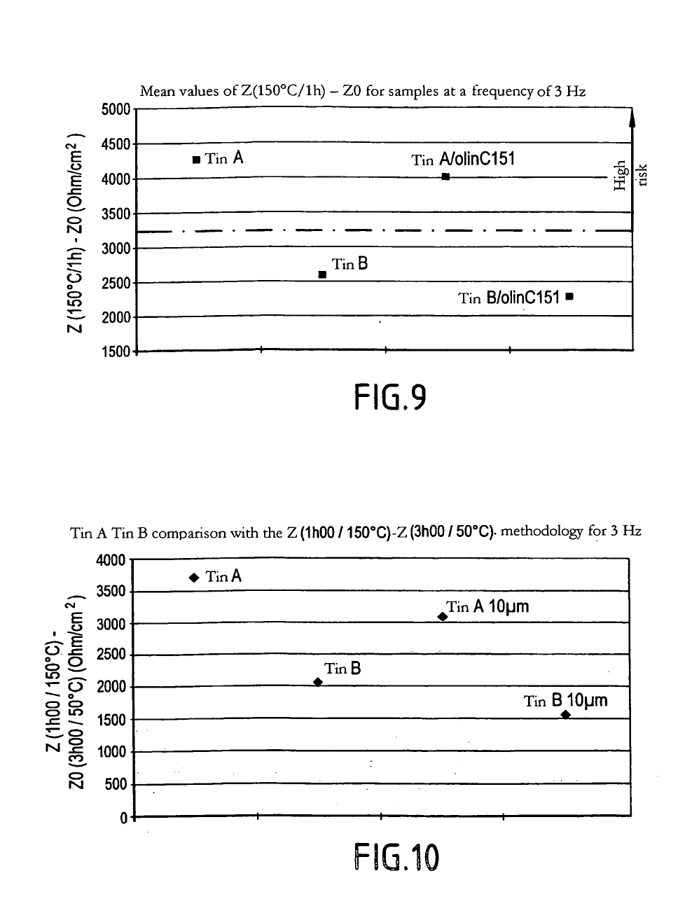

FIG. 9 shows a graph on which the mean values of the difference Z_{(1h00,150°C.)}-Z₀ for samples TIN A and TIN B, effected firstly on a substrate as described previously and secondly on substrates sold under the reference Olin C151 by the Olin Corporation, 501 Merritt Seven, Norwalk, Conn. 06856-4500 USA.

It should be noted that according to the invention, the first measurement could also be performed after thermal treatment of the deposit to be tested. Thus FIG. 10 shows a graph for the same deposits as FIG. 7, with the first measurement of Z_{(3h00/50°C.)} being taken after thermal treatment of the deposits to be tested at a temperature of 50° C. in a dry atmosphere for a period of 3 hours. The means of the difference Z_{(1h00/150°C.)}-Z_{(3h00/50°c.)} are then shown in FIG. 10. Here again, the deposits for which the differences is greatest are those that have the highest risk of whiskers appearing.

In addition, whether they are used alone or in combination, these methods of assessment according to the invention can be applied to different determination methods.

Thus, these methods can be used for comparative analyses for example.

It will be possible, for example, to use these methods to compare the variation of the electrochemical impedance of different samples in relation to a reference sample. As a function of the variation of the electrochemical impedance of the samples in relation to the variation of the electrochemical impedance over the same test time interval as the reference sample, it can then be considered that a variation of the electrochemical impedance of a value that is considerably greater than the variation of the electrochemical impedance of the reference sample, will be considered as a high risk index of whiskers appearing for the sample considered in relation to the reference sample, to the extent that, for example, the reference sample is considered as representing a very low risk of whiskers appearing. Naturally, the procedure for measuring the reference sample and the samples to be compared will be the same.

In another method of implementation, the method for assessing the risk of whiskers appearing by determining the variation of the electrochemical impedance of a metallic deposit of pure metal or metal alloy can also be used to analyse the evolution over time of an electrolytic bath, and of an associated method of electro-deposition, with a view to effecting a metallic deposit. Thus a reference deposit can be applied at the beginning of using the electrolytic bath, and then at regular intervals, control deposits which will be subjected to an assessment of the risk of whiskers appearing. Thus, to the extent that, for a test interval of the same length, the electrochemical impedance of the control deposits varies more that of the reference deposit, it can be considered that the evolution of the electrolytic bath results in a high risk of whiskers appearing, or at least, in the creation of electrolytic deposits which no longer give the same guarantees as the initial deposit.

Finally, the method of determining the risk of whiskers appearing by determining the variation of the electrochemical impedance of the deposit can be used to effect an intrinsic determination in which it will be considered that, for example, when the variation of inverse of electrochemical impedance of the deposit over the test interval reduces by a value, in absolute terms, that is greater than 2.10⁻⁵, then the deposit has a high risk of whiskers appearing.

Moreover, the different methods of the invention can be used alone or in combination, firstly to determine or preselect baths and methods of electro-deposition that have a lower risk of whiskers appearing, and then for monitoring the use of these methods of electro-deposition and electrolysis baths during production.

Naturally, various other modifications can be made to the invention without moving outside of its scope.

1. A process for assessing the risk of whiskers surface of a metallic deposit, of a pure metal or of an alloy, onto a substrate, using measurement of the electrochemical impedance of the metallic deposit.

2. A process according to claim 1, characterized in that it includes at least one stage for measuring the electrochemical impedance of the deposit and a stage for comparison of the value obtained during the measurement stage with a reference value.

3. A process according to claim 2, characterized in that it includes at least:
a first stage for measuring the electrochemical impedance of the deposit,
a second stage for measuring the electrochemical impedance of the deposit, which occurs after a given time interval, known as the test interval,
and in that during the comparison stage, the reference value is taken as the value obtained during the second measurement stage, so as to determine the evolution of the electrochemical impedance of the deposit over the test interval.

4. A process according to claim 3, characterized in that it determines the evolution of the electrochemical impedance of the deposit using the inverse value of this impedance.

5. A process according to claim 4, characterized in that it consists of attributing, to the deposit tested, a high risk index of whiskers appearing, when the reduction in absolute value of the inverse of the value of the electrochemical impedance measured at least at the beginning and end of the test interval is greater than 2.10⁻⁵.

6. A process according to one of claims 3 to claim 3, characterized in that it includes a thermal treatment of the deposit to be tested during the test interval.

7. A process according to claim 6, characterized in that it includes an oven treatment of the deposit to be tested at a temperature of greater than 45° C.

8. A process according to claim 6, characterized in that it includes an oven treatment of the deposit to be tested at a temperature of between 50° C. and 150° C.

9. A process according to claim 6, characterized in that it includes an oven treatment of the deposit to be tested at a temperature not less than 150° C. so as to annihilate (neutralise) the deposit.

10. A process according to claim 6, characterized in that it includes the following successive stages:
choosing a test interval lasting between twenty minutes and one hundred and twenty minutes,
measuring the electrochemical impedance of the deposit tested before thermal treatment,
oven treating the deposit tested during the test interval,
measuring the electrochemical impedance of the deposit tested, after thermal treatment,
calculating the relative variation of the inverse of the electrochemical impedance of the deposit tested, between the measurement effected before thermal treatment and the measurement effected after thermal treatment.

11. A process according to claim 3, characterised in that it includes:
a stage for the application of a metallic reference deposit to a substrate, and determination of the variation in the evolution of its electrochemical impedance over a test interval, with or without thermal treatment,
a stage for the application of a metallic deposit to be tested, onto a substrate of the same nature as that of the reference deposit, and determination of the variation in the evolution of its electrochemical impedance over the same test interval as for the reference deposit,
and a stage for comparing the values of variation of the electrochemical impedance of the reference deposit and the deposit to be tested.

12. A process according to claim 2, characterized in that it establishes as a reference value, either the value of the electrochemical impedance of an annihilated reference deposit or the value of the electrochemical impedance of the annihilated deposit to be tested.

13. A process according to claim 2, characterized in that the measurement stage is effected after thermal treatment of the deposit to be tested.

14. A process according to claim 1, characterized in that it includes measurement of the electrochemical impedance of the deposit to be tested by the application of a sinusoidal potential difference whose frequency is between 10 mHz and 100 kHz, and preferably between 1 Hz and 10 Hz.

15. A process according to one of claim 1, characterized in that it includes:
a substrate (2) with a series of holes (5),
and observation of any appearance of whiskers at the holes.

16. A process according to claim 15, characterized in that it employs a substrate that has a solid zone (3) for performing electrochemical impedance measurements, and a perforated zone (4) that includes a series of holes (5) to observe any appearance of whiskers.

17. A process according to claim 15, characterized in that the holes have a diameter of between 0.3 and 1.2 mm.

18. A process according to claim 15, characterized in that the substrate includes at least fifty holes.

19. A process for assessing an electrolytic bath and a method of electro-deposition, combined for the application of the deposition of a metal or of an alloy onto a substrate, with a view to determining the risks of whiskers appearing at the surface of the deposit, effected by means of the said method with the said bath, characterized in that it includes the following stages:
application of a deposit of metal or of soldering alloy onto a substrate by means of the bath and the method to be assessed,
and evaluating the risk of whiskers appearing at the surface of the deposit, effected by means of the assessment process of claim 1.

20. A process according to claim 19, characterized in that it uses as a reference value the value of the electrochemical impedance of a deposit of metal or of alloy, called the initial deposit, effected with the electrolytic bath using the method of electro-deposition before any other use of the bath.

21. A process according to claim 20, characterized in that it uses as a reference value, the value of the electrochemical impedance of the annihilated initial deposit.

22. A process according to claim 19, characterized in that it uses as a substrate a plate of conducting material.

23. A process according to claim 19, characterized in that the assessment process used in the evaluating step occurs within a period of one hundred and twenty minutes after the electro-deposition process.

24. A substrate for application of the assessment process according to claim 1, characterized in that it includes a plate (2) which, firstly, has a solid zone (3) for performing measurements of electrochemical impedance and, secondly, has a perforated zone (4) that includes a series of holes (5).

25. A substrate according to claim 24, characterized in that the holes (5) have a diameter of between 0.3 mm and 1.2 mm.

26. A substrate according to claim 24, characterized in that the perforated zone (4) includes a number of holes (5) exceeding fifty.

27. A substrate according to claim 24, characterized in that it is electrically conducting, at its surface at least.
